(19) United States
(12) Patent Application Publication
(10) Pub. No.: US 2011/0095515 A1
(43) Pub. Date: Apr. 28, 2011

(54) Clipboard with magnetic pen holder

(76) Inventor: Jeffrey D. Carnevali, Seattle, WA (US)

(21) Appl. No.: 12/589,737

(22) Filed: Oct. 28, 2009

(51) Int. Cl. B42D 5/00; B23P 11/00

(52) U.S. Cl. 281/45; 29/428

(57) ABSTRACT

A novel magnetically enhanced carrying case having a plurality of recesses formed in an inner wall, each recess having a recessed surface thereof proximate to the outer wall, and a magnet retained in each of the recesses, with the magnet being positioned substantially against the recessed surface of the recess proximate to the outer wall.

### FIELD OF THE INVENTION

The present invention relates generally to magnetic devices for holding ferrous metallic objects, and in particular to a clipboard carrying case having one or more magnets mounted internally for retaining on an outer surface thereof pens or other writing implements having ferrous metallic casings or other components.

### BACKGROUND OF THE INVENTION

Magnetic devices are generally well-known for holding ferrous metallic objects. However, such known devices are limited in their ability to provide a convenient means for retaining a pen or other writing implement within easy reach of a user of a clipboard.

### SUMMARY OF THE INVENTION

The present invention is a novel magnetically enhanced clipboard having a plurality of recesses formed in an inner wall, each recess having a recessed surface thereof proximate to the outer wall, and a magnet retained in each of the recesses, with the magnet being positioned substantially against the recessed surface of the recess proximate to the outer wall.

According to one aspect of the invention a method is provided for forming the novel magnetically enhanced clipboard, including mounting the magnets therein.

Other aspects of the invention are detailed herein.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a perspective view showing an example of the novel clipboard adapted to magnetically retain a ferrous metallic object; and

FIG. 2 is a perspective view of the novel magnetically enhanced clipboard having a back casing portion thereof removed for clarity.

### DETAILED DESCRIPTION OF PREFERRED EMBODIMENT

In the Figures, like numerals indicate like elements.

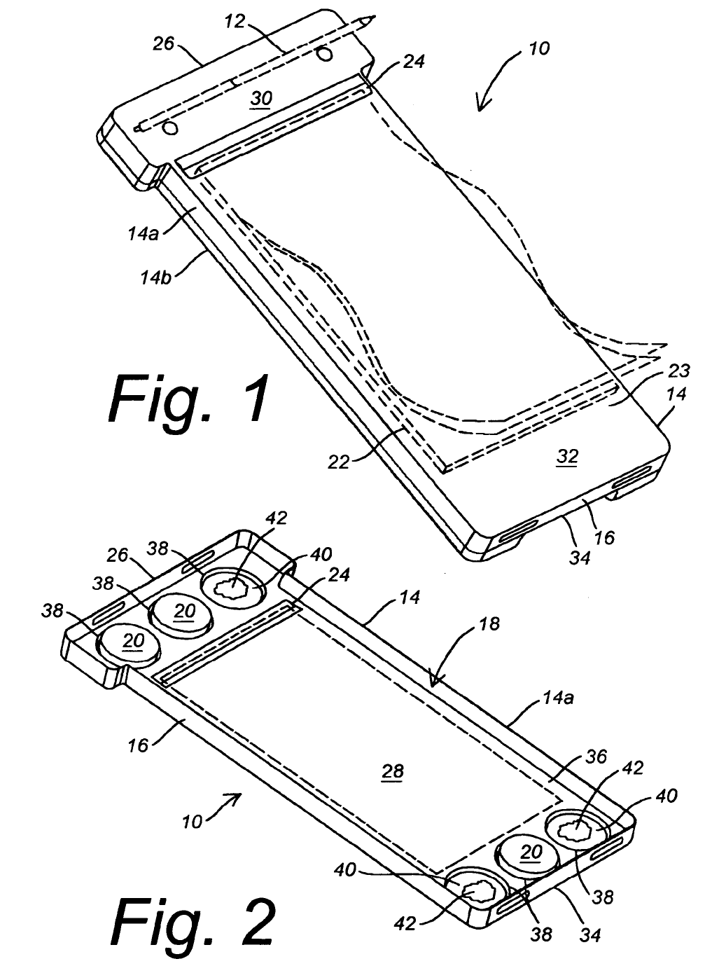

FIG. 1 is a perspective view of a clipboard 10 adapted to magnetically retain an object 12 (shown in phantom) such as a pen or other writing implement of a type having a ferrous metallic housing responsive to the pull of a magnetic field. Clipboard 10 is formed of a rigid clipboard casing 14 having a pair of mutually interconnectable front and back clipboard casing portions 14a and 14b together defining outer casing wall 16 substantially enclosing an interior cavity 18 (shown in FIG. 2). For example, front and back casing portions 14a, 14b are structured to be snapped together, optionally in a releasable manner. A plurality of magnets 20 (shown in FIG. 2) are mounted in close proximity to front casing portion 14a. Casing 14 may be formed of ferrous or nonferrous metal, or another nonferrous material such as plastic. When formed of plastic, casing 14 is optionally molded, for example by injection molding. According to one embodiment, clipboard 10 is adapted for holding a pad of pages of writing paper 22 (shown in phantom) on a substantially planar front writing surface 23 formed on outer casing wall 16 at front of clipboard 10. Accordingly, front casing portion 14a is formed with a slot 24 adjacent one end 26 thereof for receiving thereinto a support backing 28 (shown in FIG. 2) formed of heavy card stock and bonded to pad 22. Support backing 28 is slipped through slot 24 into interior cavity 18 (shown in FIG. 2) of casing 14 for retaining pad 22 on front of clipboard 10 against writing surface 23.

Preferably, slot 24 is positioned to expose at least a portion 30 of outer casing wall 16 adjacent to end 26 of front casing portion 14a where magnets 20 are positioned. Accordingly, ferrous metallic object 12 can be brought into contact with outer casing wall 16 in close proximity to magnets 20 for most effective magnetic retention of object 12.

Optionally, casing 14 is further sized to expose beyond writing pad 22 another portion 32 of outer casing wall 16 opposite from first end 26 and adjacent to a second end 34 of front casing portion 14a. When casing 14 is structured to expose second portion 32, ferrous metallic object 12 is retained in contact with outer casing wall 16 in close proximity to magnets 20 adjacent to second casing portion 32. Accordingly, one or more ferrous metallic object 12 are alternately retained in different locations 30, 32 of front casing portion 14a.

FIG. 2 is a perspective view of clipboard 10 having back casing portion 14b removed for clarity. Front and back casing portions 14a, 14b form an inner casing wall 36 defining interior cavity 18 substantially enclosed by casing 14. As illustrated, support backing 28 of pad 22 is slipped through slot 24 into an interior cavity 18 of casing 14 for retaining pad 22 on front of clipboard 10 against writing surface 23.

A first plurality of recesses 38 are formed in inner wall 36 of casing 14 with each recess 38 forming a recessed surface 40 thereof proximate to writing surface 23 on outer casing wall 16 of front casing portion 14a. For example, a plurality of recesses 38 are positioned at portion 30 of outer casing wall 16 between pad slot 24 and first end 26 of front casing portion 14a. One magnet 20 is mounted in each recess 38 with a means 42 for retaining magnet 20 therein. For example, retaining means 42 is an adhesive adhering agent of a conventional type known for compatibility with both casing 14 and magnet 20.

Optionally, a second plurality of recesses 38 are formed in inner wall 36 of casing 14 proximate to writing surface 23 at second portion 32 of outer casing wall 16 exposed between writing pad 22 and second end 34 of front casing portion 14a. Each recess 38 of second plurality forms recessed surface 40 thereof proximate to outer wall 16 of front casing portion 14a. One magnet 20 is mounted in each recess 38 with retaining means 42 for retaining magnet 20 therein.

After magnets 20 are mounted in recesses 38 with retaining means 42, front and back casing portions 14a, 14b are mutually interconnected, such as by snapping together. Thereafter, one or more ferrous metallic objects 12 are brought into contact with outer casing wall 16 for effective removable magnetic retention relative to either portion 30 or 32 of front casing portion 14a in close proximity to magnets 20. When ferrous metallic object 12 is a pen or other writing implement, it is readily available for use jotting notes or other information on writing pad 22.

FIGS. 1 and 2 further describe a method of forming magnetically enhanced clipboard 10, wherein the method includes: forming outer casing 14 defining outer casing wall 16 and inner casing wall 36. Inner casing wall 36 defines interior cavity 18 substantially within outer casing 14. A plurality of recesses 38 is formed in inner casing wall 36 with each recess 38 having a recessed surface 40 thereof proximate to outer casing wall 16. Magnets 20 are retained in each of one or more of recesses 38 in positions substantially against recessed surface 40 of recess 38 proximate to outer casing wall 16. Retaining means 42 is deposited in recesses 38 for retaining magnet 20 therein.

Depositing means 42 for retaining magnet 20 in recess 38 include, for example, depositing a bonding agent adhering magnet 20 into recess 38. For example, depositing bonding agent retaining means 42 for adhering magnet 20 into recess 38 further includes adhering magnet 20 against recessed surface 40 of recess 38 proximate to outer casing wall 16.

According to one embodiment, one of magnets 20 is retained in each of a plurality of different ones of the plurality of recesses 38. For example, forming in inner casing wall 36 includes forming first and second pluralities of recesses 38 in spaced apart positions in inner casing wall 36 in the vicinity of portions 30, 32 of outer casing wall 16 adjacent to opposite ends 26, 34 of front casing portion 14a. Thereafter, a magnet 20 is optionally retained in at least one of each of the spaced apart first and second pluralities of recesses 38.

According to another embodiment, forming outer casing 14 includes forming the pair of mutually interconnectable front and back outer casing portions 14a, 14b each having outer casing wall 16 and inner casing wall 36, and further includes mutually interconnecting the pair of front and back outer casing portions 14a, 14b. Additionally, forming outer casing 14 further includes forming substantially planar writing surface 23 on outer casing wall 16.

While the preferred and additional alternative embodiments of the invention have been illustrated and described, it will be appreciated that various changes can be made therein without departing from the spirit and scope of the invention. Accordingly, the inventor makes the following claims.

What is claimed is:

1. A magnetically enhanced clipboard, comprising:
a clipboard casing defining an outer wall and an inner wall, the outer wall comprising means for retaining a pad of pages of writing paper proximate to a writing surface thereof;
an interior cavity defined by the inner wall and substantially enclosed thereby; and
a magnet retained within the interior cavity in a position substantially against the inner wall proximate to the outer wall adjacent to the writing surface.

2. The clipboard of claim 1, further comprising a means for retaining the magnet in the position.

3. The clipboard of claim 2, wherein the means for retaining the magnet further comprises a bonding agent coupling the magnet in the position.

4. The clipboard of claim 2, further comprising a plurality of the magnets, one of the magnets being retained in a position within the interior cavity substantially against the proximate to the outer wall different from a position of a different one of the magnets.

5. The clipboard of claim 4, wherein the outer casing further comprises a pair of mutually interconnectable outer casings each comprising an outer wall and an inner wall, and further comprising the interior cavity defined between the inner walls of the pair of outer casings.

6. The clipboard of claim 5, wherein the position of one of the magnets is adjacent to a first end of the writing surface, and a the different position of the different one of the magnets is adjacent to a second opposite end thereof.

7. A magnetically enhanced clipboard, comprising:
an outer clipboard casing defining an outer wall and an inner wall, the outer wall comprising a writing surface;
means for retaining a pad of pages of writing paper proximate to the writing surface of the outer wall;
an interior cavity defined by the inner wall and substantially enclosed thereby;
a plurality of recesses formed in the inner wall, each recess comprising a recessed surface thereof proximate to the outer wall; and
a magnet retained in each of one or more of the recesses, the magnet being positioned substantially against the recessed surface of the recess proximate to the outer wall.

8. The clipboard of claim 7, further comprising a means for retaining the magnet in the recess.

9. The clipboard of claim 8, wherein the means for retaining the magnet in the recess further comprises a bonding agent coupling the magnet into the recess.

10. The clipboard of claim 8, further comprising a plurality of the magnets, each one of the magnets being retained in a different one of the plurality of recesses.

11. The clipboard of claim 10, wherein the outer casing further comprises a pair of mutually interconnectable outer casings each comprising an outer wall and an inner wall, and further comprising the interior cavity defined between the inner walls of the pair of outer casings.

12. A method of forming a magnetically enhanced clipboard, the method comprising:
forming a clipboard casing defining an outer wall and an inner wall, including forming a writing surface on the outer wall thereof;
providing a means for retaining a pad of pages of writing paper proximate to the writing surface on the outer wall of the clipboard casing;
of the inner wall, defining an interior cavity substantially within the clipboard casing;
forming in the inner wall a plurality of recesses each comprising a recessed surface thereof proximate to the outer wall; and
retaining in each of one or more of the recesses a magnet positioned substantially against the recessed surface of the recess proximate to the outer wall.

13. The method of claim 12, further comprising depositing in the recesses a means for retaining the magnet in the recess.

14. The method of claim 13, wherein depositing the means for retaining the magnet in the recess further comprises depositing a bonding agent adhering the magnet into the recess.

15. The method of claim 14, wherein depositing a bonding agent adhering the magnet into the recess further comprises adhering the magnet against the recessed surface of the recess proximate to the outer wall.

16. The method of claim 13, further comprising retaining one of the magnets in a plurality of different ones of the plurality of recesses.

17. The method of claim 16, wherein forming the clipboard casing further comprises forming a pair of mutually interconnectable clipboard casings each comprising corresponding portions of the outer wall and inner wall, and further comprising mutually interconnecting the pair of clipboard casings.

18. The method of claim 16, wherein forming a pair of mutually interconnectable clipboard casings further comprises forming means for snappingly interconnecting the pair of clipboard casings.

19. The method of claim 16, wherein forming in the inner wall a plurality of recesses further comprises forming first and second pluralities of recesses in spaced apart positions in the inner wall.

20. The method of claim 19, wherein retaining in each of one or more of the recesses a magnet further comprises retaining a magnet in at least one of each of the spaced apart first and second pluralities of recesses.
